(19) United States
(12) Patent Application Publication
(10) Pub. No.: US 2011/0093528 A1
(43) Pub. Date: Apr. 21, 2011

(54) METHOD AND SYSTEM FOR ENABLING INTERACTION WITH A CLIENT TO EXTRACT DATA FROM A USER

(75) Inventors: SHAKEEL AHAMED, BANGALORE (IN); SRINIVASA RAO MORLA, BANGALORE (IN)

(73) Assignee: SAMSUNG ELECTRONICS CO., LTD., SUWON-SI (KR)

(21) Appl. No.: 12/904,525

(22) Filed: Oct. 14, 2010

(30) Foreign Application Priority Data
Oct. 15, 2009 (IN) 2515/CHE/2009
Oct. 5, 2010 (KR) 10-2010-0096880

(51) Int. Cl. G06F 15/16

(52) U.S. Cl. 709/203

(57) ABSTRACT

A method and system for providing interaction with a client to extract data from a user. The method includes providing a user interface to the client, receiving data from a user of the client on a server, categorizing the data based on one or more parameters, processing the data based on the categorization, and updating the client based on the processing.

### PRIORITY

This application claims priority to an application, which was filed with the Indian Patent Office on Oct. 15, 2009 and assigned Serial No. 2515/CHE/2009, and to an application, which was filed in Korean Intellectual Property Office on Oct. 5, 2010 and assigned serial No. 10-2010-0096880, the contents of which are incorporated herein by reference.

### BACKGROUND OF THE INVENTION

1. Field of the Invention

The present disclosure relates to the field of communication, and more particularly, to a method and system for enabling interaction with a client to extract data from a user.

2. Description of the Related Art

Traditionally, idea sharing between vendors and users occur by organizing innovation-related events. Such events enable the vendors to meet one or more users of a product or a service to recognize views of the users. In an existing approach, views and ideas are collected from select users by using questionnaires, feedback forms, and other techniques that require immense manual effort. Additionally, because few users respond to such techniques, there is a chance that the intended target users, i.e., those with better knowledge and inventiveness or belonging to different educational backgrounds, may not contribute. Further, sharing views and ideas in a group can often restrain the flow of ideas. Consequently, the existing approaches cannot be continually pursued and thus the views and ideas of users are not efficiently communicated.

### SUMMARY OF THE INVENTION

The present invention is designed to address at least the above-mentioned problems and/or disadvantages and to provide at least the advantages described below. Accordingly, an aspect of the present invention provides an efficient method and system for enabling interaction with a client to extract data from a user.

In accordance with an aspect of the present invention, a method is provided for enabling interaction with a client to extract data from a user. The method includes providing a user interface to the client; receiving the data from the user of the client on a server; categorizing the data based on one or more parameters; processing the data based on the categorization; and updating the client based on the processing.

In accordance with another aspect of the present invention, a system is provided for enabling interaction with a client to extract data from a user. The system includes the client including a user interface electronically communicable with a server through a network and providing the data to the server; and the server including a processor that is communicable with the client, the processor including a categorization unit to categorize the data based on one or more parameters, a processing unit to process the data based on the categorization, and an updating unit to update the client based on the processing.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of an environment for enabling interaction with a client to extract data from a user, in accordance an embodiment of the present invention;

FIG. 2 is a block diagram of a system for enabling interaction with a client to extract data from a user via a server, in accordance with an embodiment of the present invention; and

FIG. 3 is a flowchart illustrating a method for enabling interaction with a client to extract data from a user, in accordance with an embodiment of the present invention.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF EMBODIMENTS OF THE INVENTION

Reference will now be made in detail to various embodiments of the present invention with reference to the accompanying drawings. The following detailed description includes specific details in order to provide a thorough understanding of the present invention. However, it will be apparent to those skilled in the art that the present invention may be practiced without such specific details. It should be observed that method steps and system components have been represented by conventional symbols in the figures, showing only specific details that are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities.

The embodiments of the present disclosure provide a method and system for enabling interaction with a client to extract data from a user.

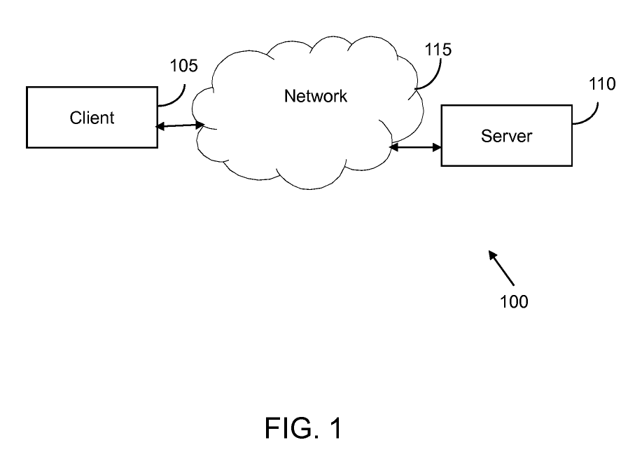

FIG. 1 is a block diagram of a system 100 enabling interaction with a client 105 to extract data from a user, in accordance with an embodiment of the present invention.

Referring to FIG. 1, the system 100 includes a client 105 that provides data to a server 110. For example, the server 110 can represent a vendor. Examples of the client 105 include, but are not limited to, a mobile communication device, a personal digital assistant, a laptop, an electronic appliance, and a personal computing device. The client 105 communicates with the server 110 via a network 115. Examples of the network 115 include, but are not limited to, a local area network, a wide area network, a wired network, a metropolitan area network, internet, Bluetooth®, Zigbee®, and a wireless network. The data can include one of a text data, an audio data, a video data or a combination thereof. The data can be ideas, views, suggestions, concepts, issues or concerns of the user of the client 105. The data can be related to one or more products or services. The data can be transmitted from the client 105 to the server 110. In some embodiments, the data is transmitted as a short message service or a multimedia messaging service.

The client 105 includes a user interface that accepts data from the user and provides data to the user. The user interface is a dedicated interface that allows the user to interact with the server 110 via the interface. In some embodiments, the user interface can be a custom interface.

The server 110 receives the data transmitted from the user interface of the client 105 via the network 115. In some embodiments the user interface can be replaced with a widget.

The server 110 categorizes the data based on one or more parameters. Examples of the parameters include, but are not limited to, validity of the data, one or more data categories, client characteristics, and one or more keywords. Examples of the client characteristics include, but are not limited to, data identifying the client 105, client location, mobile number of the client 105, model number of the client 105, type of client 105, and capability of the client 105.

The server 110 provides one or more updates to the client 105, via the user interface, based on the data. The client 105 then displays the updates to the user via the user interface. In some embodiments, the user modifies the data on the server 110. The modified data can then be synchronized with the server 110.

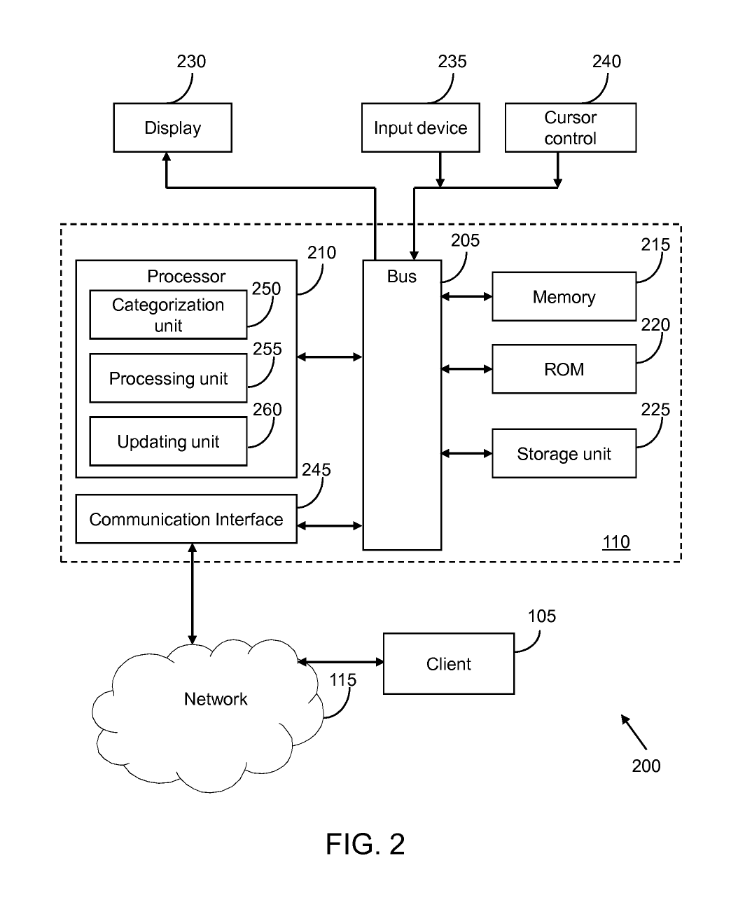

FIG. 2 is a block diagram of a system 200 for enabling interaction with a client 105 to extract data from a user, in accordance with an embodiment of the present invention.

Referring to FIG. 2, the system 200 includes a server 110 in communication with the client 105, via a network 115. The server 110 includes a bus 205 or other communication mechanism for communicating the data. The data can include one of a text data, an audio data, a video data, or a combination thereof. The client 105 includes a user interface in electronic communication with the server 110 via the network 115.

The user interface is a dedicated interface to allow the user to interact with the server 110. The user transmits the data to the server 110 via the user interface. Examples of the user interface include, but are not limited to, a graphical user interface, a touch user interface, a command line interface, a web interface, and a tactile interface.

The server 110 receives the data from the user of the client 105.

The system 200 includes a processor 210 coupled with the bus 205 for consolidating the data received from the user of the client 105 at the server 110. The server 110 also includes a memory 215, for example a Random Access Memory (RAM) or other dynamic storage device, coupled to the bus 205 for storing the data, which can be used by the processor 210. The memory 215 can be used for storing any temporary data required. The server 110 further includes a Read Only Memory (ROM) 220 or other static storage device coupled to the bus 205 for storing static data for the processor 210.

The server 110 can be coupled via the bus 205 to a display 230, for example a Cathode Ray Tube (CRT) or a Liquid Crystal Display (LCD). An input device 235, including alphanumeric and other keys, is coupled to the bus 205 for communicating an input to the processor 210. Another type of user input device 235 may be a cursor control 240, for example, a mouse, a trackball, or cursor direction keys for communicating the input to the processor 210 and for controlling cursor movement on the display 230.

Various embodiments of the present invention are related to the use of the server 110 for implementing the techniques described herein.

In accordance with an embodiment of the present invention, the techniques are performed by the processor 210 using the data included in the memory 215. The data can be read into the memory 215 from another machine-readable medium, for example a storage unit 225. The storage unit 225, for example a magnetic disk or an optical disk, can be coupled to the bus 205 to store the data received from the client 105.

The term “machine-readable medium” as used herein refers to any medium that participates in providing data that causes a machine to operate in a specific fashion.

In accordance with an embodiment implemented using the server 110, various machine-readable mediums are involved, for example, in providing the data to the processor 210. The machine-readable medium can be a storage media. Storage media includes both non-volatile media and volatile media. Non-volatile media includes, for example, optical or magnetic disks, for example, the storage unit 225. Volatile media includes dynamic memory, for example, the memory 215. All such media is tangible to enable the data carried by the media to be detected by a physical mechanism that reads the data into a machine

Common forms of machine-readable medium include, for example a floppy disk, a flexible disk, hard disk, magnetic tape, or any other magnetic medium, a CD-ROM, any other optical medium, a RAM, a PROM, and EPROM, a FLASH-EPROM, any other memory chip or cartridge.

The server 110 also includes a communication interface 245 coupled to the bus 205. The communication interface 245 provides a two-way data communication coupling to the network 115. For example, the communication interface 245 can be a Local Area Network (LAN) card to provide a data communication connection to a compatible LAN. Wireless links can also be implemented. In any such implementation, the communication interface 245 sends and receives electrical, electromagnetic or optical signals that carry digital data streams representing various types of data. The communication interface 245 can be a universal serial bus port. The server 110 is in electronic communication with the client 105 through the communication interface 245 and the network 115.

The processor 210 includes one or more processing units, for example, a categorization unit 250, a processing unit 255, and an updating unit 260. The categorization unit 250 can categorize the data received from the client 105 based on one or more parameters. Examples of the parameters include, but are not limited to, validity of the data, one or more data categories, client characteristics, and one or more keywords. The client characteristics can include, but are not limited to, data identifying the client 105, client location, mobile number of the client 105, type of client 105, and capability of the client 105. The processing unit 255 processes the data based on the categorization. The updating unit 260 updates the client 105 based on the processing. One or more updates are displayed to the user via a user interface in the client 105. In some embodiments, the updating unit 260 updates the user periodically. The processor 210 can also include a conversion unit for converting an audio data, received from the client 105, to a text data. The categorization unit 250 can further include a keyword generation unit and a comparison unit. The keyword generation unit generates one or more keywords based on the data. The comparison unit compares the keywords with one or more stored keywords in the server 110.

The client 105 can include or can be coupled to one or more components similar to the server 110. For example, the client 105 can be coupled to a display unit that displays the data categories in the user interface and the updates from the server 110. In another example, the client 105 can be coupled to an input device through which the user inputs the data or modifications to the data.

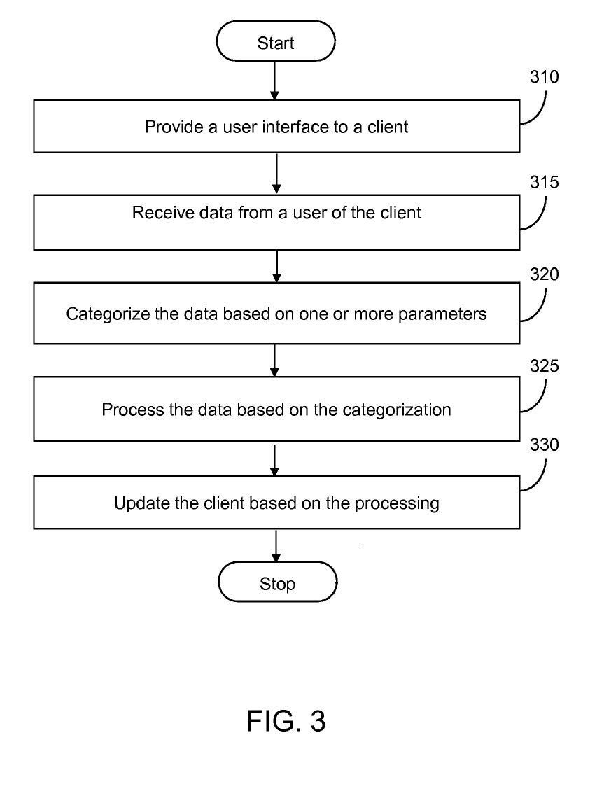

FIG. 3 is a flowchart illustrating a method for enabling interaction with a client to extract data from a user, in accordance with an embodiment of the present invention.

In step 310, a user interface is provided to the client. The client is in communication with a server via a network. The server can represent a vendor. The user interface is a dedicated interface used to collect the data from the user of the client by the server and allows the user to interact with the server. In some embodiments, the user interface can be a custom interface. Examples of the user interface include, but are not limited to, a graphical user interface, a touch user interface, a command line interface, a web interface, and a tactile interface. The user using the client, for example, a mobile phone, can transmit data individually to the server via the user interface. In some embodiments the user interface can be replaced with a widget. The data can include one of a text data, an audio data, a video data or a combination thereof. The data can be views, suggestions, ideas, concepts, issues or concerns of the user. The data can be related to one or more products or services. In some embodiments, the data is transmitted via a short message service or a multimedia messaging service.

The user interface displays one or more data categories to the user. The user can then select a data category from the data categories for entering the data. Examples of the data categories include, but are not limited to, devices, for example mobile, television, and camera, business idea, public utility idea, and religion specific idea.

In some embodiments, each of the data categories includes one or more sub categories. For example, a data category public utility can include the sub categories of ideas to fight crime, ideas to help disabled, ideas for rural India, and education related ideas. The user can select one or more of the data categories or the sub categories in the user interface.

In some embodiments, if the data category required by the user is not present any of the data categories in the user interface the user can create the data category. In some embodiments, one or more templates can be included in the user interface to allow the user to create the data. The templates can include one or more fields, for example title, explanation, and an attachment. The user then provides the data in the data category using one of the templates. The data is transmitted from the client to the server.

In step 315, the data from the user of the client is received on the server. The server can receive the data in different formats, for example as the text data, the audio data, the video data or a combination thereof. In some embodiments, the audio data can be converted to the text data using a speech to text converter on the server.

In some embodiments, the server tags metadata to the data. Examples of the metadata include, but are not limited to, an index, a data code, a number identifying the client, a date of receiving the data, a current status of data processing, client characteristics, and information from the vendor. The index identifies a sequence of the data received from the user. The data code is a unique code identifying the user. The data code is a combination of the number identifying the client and the index. The server associates the unique code with the user to identify the user on receiving the data. Examples of the current status can include, but is not limited to, data sent, data under study, data approved, data not approved, data rewarded, and data retry. The client characteristics can include, but are not limited to, data identifying the client, client location, mobile number of the client, model number of the client, type of client, and capability of the client. The information from the vendor can include reward information, a web link including information for the user, a target date of receipt of one or more updates for the data under study, and general comments regarding the data.

In step 320, the data is categorized on the server based on one or more parameters. The parameters include, but are not limited to, validity of the data, the data categories, client characteristics, and one or more keywords. The server categorizes the data as either valid or invalid based on the validity of the data. If the data is invalid, the server can block any further transmission of data from the user and can discard the data. If the data is valid, the server can further categorize the data into the data categories. The server generates one or more keywords based on the data. The server then compares the keywords with one or more stored keywords. The server categorizes the data. The data received from the user of the client can be stored for further processing.

In step 325, the server processes the data based on the categorization. In order to process the data, the server retrieves the stored data. The data on the server is then analyzed by comparing the one or more fields associated with the data with an existing data on the server. The data is then evaluated based on the analysis. The user can be rewarded based on the evaluation of the data.

In step 330, the client is updated based on the processing. One or more updates are transmitted to the client via the short message service or the multimedia messaging service. The updates are displayed to the user via the user interface of the client.

In some embodiments, the user is periodically updated based on the processing. The updates indicate a status of the data, for example data received at the server, date under study, data approved, data rewarded, and data retry.

In some embodiments, the updates include additional fields. Examples of the additional fields include, but are not limited to, reward information, the web link including information for the user, the target date of receipt of the updates for the data under study, general comments regarding the data.

In some embodiments, the updates include the metadata tagged with the data.

In some embodiments, the user can access the data from the server via the user interface to either check status of the data or to modify the data. The modified data can then be synchronized with the server. The server can transmit updates to the client based on the modification.

In the preceding description, the present disclosure and its advantages have been described with reference to certain embodiments. However, it will be apparent to a person of ordinary skill in the art that various modifications and changes can be made, without departing from the scope of the present disclosure, as set forth in the claims below. Accordingly, the scope of the present invention should not be limited to the description of the embodiment, but defined by the accompanying claims and equivalents thereof.

What is claimed is:

1. A method for enabling interaction with a client to extract data from a user, the method comprising the steps of:
providing a user interface to the client;
receiving the data from the user of the client on a server;
categorizing the data based on at least one parameter;
processing the data based on the categorization; and
updating the client based on the processing.

2. The method of claim 1, further comprising storing the data received from the user of the client on the server.

3. The method of claim 1, further comprising:
selecting a data category by the user from data categories in the user interface of the client;
creating the data category by the user, if the data category is not present in the data categories;
providing the data in the data category by the user;
transmitting the data from the client to the server; and
receiving an update from the server based on the data.

4. The method of claim 3, further comprising accessing the data associated with the client from the server.

5. The method of claim 4, further comprising:
modifying, by the user, the data on the server; and
synchronizing the data with the server based on the modification to the data.

6. The method of claim 1, wherein the at least one parameter comprises validity of the data, a data category, a client characteristic, and a keyword.

7. The method of claim 1, wherein categorizing the data comprises:
generating a key word based on the data;
comparing the key word with a plurality of stored key words; and
categorizing the data based on a result of the comparison.

8. The method of claim 1, wherein processing the data comprises:
retrieving the data of the client on the server;
analyzing the data on the server; and
evaluating the data based on a result of the analysis.

9. The method of claim 1, wherein the data comprises at least one of text data, audio data, and video data.

10. The method of claim 9, further comprising converting the audio data received from the client to the text data.

11. A system for interacting with a client to extract data from a user, the system comprising:
the client including a user interface that is electronically communicable with a server through a network and providing the data to the server; and
the server including a processor that is electronically communicable with the client, the processor including a categorization unit to categorize the data based on at least one parameter, a processing unit that processes the data based on a result of the categorization, and an updating unit that updates the client based on a result of the processing.

12. The system of claim 11, wherein the data comprises at least one of text data, audio data, and video data.

13. The system of claim 11, wherein the server further comprises a storage unit for storing the data from the client.

14. The system of claim 11, wherein the processor further comprises a conversion unit for converting the data including audio data received from the client to a text data.

15. The system of claim 11, wherein the categorization unit further comprises:
a keyword generation unit for generating a key word based on the data; and
a comparison unit for comparing the key word with a plurality of stored key words.
